(19) United States
(12) Patent Application Publication
(10) Pub. No.: US 2026/0028728 A1
(43) Pub. Date: Jan. 29, 2026

(54) METHODS AND SYSTEMS FOR ACCELERATING BRINE POND EVAPORATION USING WASTE HEAT

(71) Applicant: Chevron U.S.A. Inc., San Ramon, CA (US)

(72) Inventors: Michael Patrick SHEA, Millcreek, UT (US); Robert E Lee MARSHALL, IV, Holladay, UT (US)

(21) Appl. No.: 19/276,930

(22) Filed: Jul. 22, 2025

Related U.S. Application Data
(60) Provisional application No. 63/675,717, filed on Jul. 25, 2024.

(51) Int. Cl. C25B 9/67; C25B 1/04; C25B 9/19; F24H 1/14; F24H 4/02; F24S 20/00

(52) U.S. Cl. CPC C25B 9/67; C25B 1/04; C25B 9/19; F24H 1/14; F24H 4/02; F24S 20/00

(57) ABSTRACT

The present application relates generally to methods and systems for accelerating the evaporation of brine pond water. In one embodiment the application pertains to an integrated process for producing hydrogen wherein waste heat evaporates the brine water. The process comprises producing hydrogen and heat from water using an electrolyzer and then heating a heat transfer fluid with the heat from the electrolyzer. The heated heat transfer fluid is pumped to a heat exchanger where it heats a brine solution from the brine pond to increase its evaporation.

### CROSS-REFERENCE TO RELATED APPLICATIONS

This application claims priority to U.S. provisional application having the Ser. No. 63/675,717 filed on Jul. 25, 2024, which application is incorporated herein by reference.

### FIELD OF THE INVENTION

The present invention relates generally to processes and systems for accelerating brine pond evaporation using waste heat from, for example, an electrolyzer producing hydrogen.

### BACKGROUND AND SUMMARY

It is often desirable to store produced hydrogen, carbon dioxide, or other substances in large underground caverns. Such caverns may be created by hollowing out sections of salt domes using a water solution to dissolve the salt. Such caverns are more efficient storage for substantial volumes of gases, such as hydrogen, and eliminate and/or reduce the need for constructing and using expensive, large-scale storage tanks.

A byproduct of the cavern creation process is brine, which is water comprising a high concentration of sodium chloride, calcium chloride, minerals, and other dissolved solids. The brine typically requires disposal and/or treatment. Conventionally, the brine is stored in large evaporation ponds, where it gradually evaporates. However, the evaporation process may be slow and can take up to 15 years or more for a single pond to fully evaporate. As the number of brine ponds grows, the land needed to build additional brine ponds increases. Therefore, methods and systems to accelerate the evaporation of the brine are needed so that land impacts may be reduced. It would be beneficial if such methods and systems were not energy, equipment, or capital intensive. Advantageously, the systems and methods described herein provide such methods and systems.

In one embodiment this application pertains to an integrated process for producing hydrogen. Hydrogen and heat are produced from water using an electrolyzer. A heat transfer fluid is heated with the heat from the electrolyzer and pumped to a heat exchanger. A brine solution is pumped from a brine pond (which may additionally or alternatively comprise brine in a salt cavern) to the heat exchanger comprising the heated transfer fluid to heat the brine solution. Next, the heated brine solution is pumped into one or more brine ponds thereby increasing the evaporation rate.

In another embodiment the application pertains to a process for evaporating brine from a brine pond. The process comprises heating a heat transfer fluid with waste heat and pumping the heated heat transfer fluid to a heat exchanger. A brine solution is pumped from the brine pond to the heat exchanger comprising the heated transfer fluid to heat the brine solution. The heated brine solution is then pumped into the brine pond, a second brine pond, or both to increase the evaporation rate of the pond.

In another embodiment the application pertains to a system comprising an electrolyzer with a heat exchanger fluidly connected to the electrolyzer. A first pump is configured to pump a heated heat transfer fluid from the electrolyzer to the fluidly connected heat exchanger. The system has a second pump fluidly connected to a brine solution and the heat exchanger. The second pump is configured to pump the brine solution to the heat exchanger to form heated brine solution.

### BRIEF DESCRIPTION OF THE DRAWINGS

So that the way the above recited features, advantages, and objects of the present invention are attained and can be understood in detail, a more particular description of the invention, briefly summarized above, may be had by reference to the embodiments thereof which are illustrated in the appended drawings. It is to be noted, however, that the appended drawings only illustrate preferred embodiments of this invention and are therefore not to be considered limiting of its scope, for the invention may admit to other equally effective embodiments that vary only in detail. In the drawings:

FIG. 1 shows a representative process and system components.

FIG. 2 shows a representative shell and tube heat exchanger that may be employed in the system.

FIG. 3 shows the temperature of fluids at various points in the process of Example 2.

FIG. 4 shows that Example 2 yields a heated brine of 140° F. at the brine tube side outlet.

FIG. 5 shows that the increase in brine pond temperature depends on brine volume within the pond.

FIG. 6 shows an embodiment which further employs a solar absorber.

### DETAILED DESCRIPTION

Certain terms are used throughout the following description and claims to refer to particular system components. As one skilled in the art will appreciate, different companies may refer to a component by different names.

### Definitions

The terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s) but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of +10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

The term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

Unless defined otherwise, all technical and scientific terms used herein have the same meanings as commonly understood by one of skill in the art to which the disclosed invention belongs. All citations referred herein are expressly incorporated by reference.

### General Process and System

In one embodiment, the application pertains to a process and a system for evaporating brine and/or accelerating the evaporating of brine from a brine pond. The process comprises heating a heat transfer fluid with waste heat and pumping the heated heat transfer fluid to a heat exchanger. The brine solution is pumped from the brine pond to the heat exchanger comprising the heated transfer fluid to heat the brine solution. The heated brine solution is pumped into the brine pond, a second brine pond, or both. Even a modest increase in temperature of the brine pond may significantly enhance the rate of evaporation. Empirical evidence suggests that an evaporation rate can approximately double with every 10° C. (18° F.) increase in temperature depending upon the conditions.

### Waste Heat

The source of the waste heat employed in the processes and systems is not particularly critical so long as it is sufficient to heat a brine solution to enhance evaporation of water in a given process or system. In one embodiment the source of the waste heat is from one or more electrolyzers which are employed to produce hydrogen and heat from water.

As described above, the waste heat may be employed from other industrial facilities that are located near enough to the brine ponds to be effectively employed. Such industrial facilities may include oil and gas related facilities, chemical plants, or data centers. The waste heat from such facilities may be employed in a similar manner as described herein with respect to electrolyzers.

### Electrolyzers

The specific type of electrolyzer is not particularly critical so long as the electrolyzer is of a type that generates sufficient heat that can be used in the processes and systems. In some embodiments, the one or more electrolyzers producing the waste heat may be polymer electrolyte membrane (PEM) electrolyzers, alkaline electrolyzers, or a system comprising a combination of both types of electrolyzers.

### Heat Exchangers and Heat Transfer Fluid

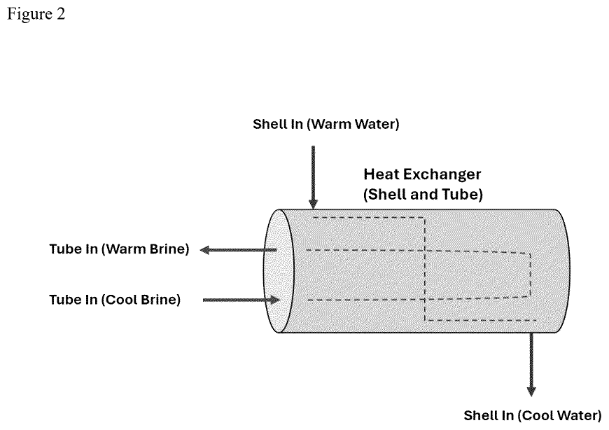

The specific heat exchanger and heat transfer fluid employed therein are not particularly critical so long as they are compatible with each other to transfer heat to the brine solution such that it evaporates faster. Heat exchangers that may be employed include, for example, shell and tube heat exchangers, plate and frame heat exchangers, plate heat exchangers, tube or pipe heat exchangers and the like. The specific heat exchanger employed may vary depending upon such factors as the heat transfer fluid, the brine solution composition, and the initial and desired temperatures. A representative shell and tube heat exchanger that may be employed is shown in FIG. 2.

As shown in FIG. 2 the shell and tube heat exchanger comprises multiple tubes enclosed within a cylindrical shell. The one in FIG. 2 is comprised of titanium tubes but the tubes may alternatively comprise other metals such as copper, steel, or alloys. The tubes facilitate heat exchange between the heat transfer fluid and the brine solution. The heat transfer fluid circulates inside the tubes, while the brine solution flows outside the pipes within the shell. Alternatively, the shell and tube heat exchanger could be employed with the brine solution circulating inside the tubes, while the heat transfer fluid flows outside the pipes within the shell.

The specific heat transfer fluid may vary depending upon the design of the system and process, the amount of the waste heat, and equipment employed. The heat transfer fluid is preferably a liquid. Useful liquids typically include those with a low viscosity and high thermal capacity. Liquids that may be useful herein comprise water, glycols such as, for example, C₁-C₆ aliphatic glycols, and mixtures thereof. If the waste heat is from a data center, then, in addition to the previously mentioned liquids, hydrocarbon oils or fluorinated hydrocarbons such the NOVEC™ line of fluids available from 3M may be useful as the heat transfer fluid.

### Enhanced Evaporation

The degree to which the evaporation of the water from the brine solution is enhanced will vary depending upon its initial temperature, the amount of heat added, and the specifics of circulation in the heat exchanger. Generally, the evaporation rate could double with every 10 degree increase in temperature. In some embodiments, the heated brine solution from the heat exchanger is at least about 5, or at least about 10 or more degrees Fahrenheit warmer than the brine solution from the brine pond.

### Optional Components

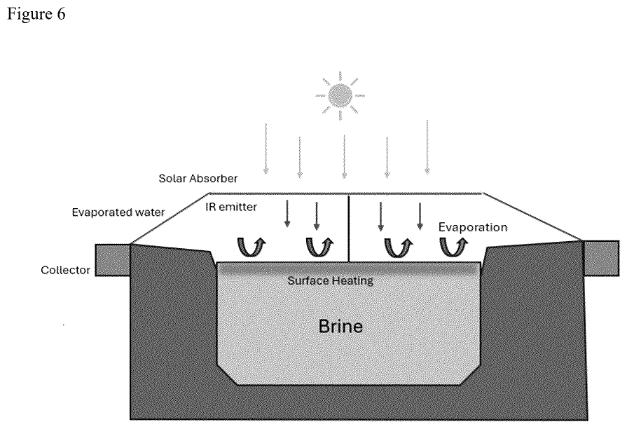

If desired, other components may be included in the processes and systems. For example, heat pumps could be employed to increase the temperature of the heat transfer fluid, the brine solution (before or after heating in the heat exchanger), or both. Additionally or alternatively, a solar absorber may be employed to at least partially cover or to fully cover a brine pond. The solar absorber comprises a translucent cover that allows sunlight to penetrate while capturing evaporated water, effectively turning the brine pond into a solar-powered desalination unit as shown in FIG. 6.

As shown in FIG. 6, the solar absorber (also referred to as a solar umbrella) is designed to accelerate brine pond evaporation under a large translucent sheet, which captures evaporated water for recycling purposes. The captured water, once condensed, may then be purified and recycled back into the electrolyzers for hydrogen production. Using such a closed-loop system both conserves water and reduces operational costs by leveraging solar energy to increase the evaporation rate, thereby reducing the dependency on external water supplies and minimizing environmental impact.

### Representative System and Process

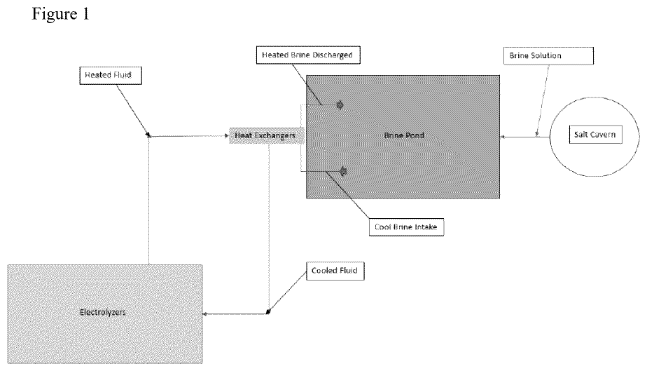

A representative system and process is shown in FIG. 1 wherein the closed loop system comprises a brine solution circuit and a heat transfer fluid circuit. The brine solution circuit involves the brine solution from the evaporation ponds. Cool brine solution is pumped from the evaporation ponds into a heat exchanger where it contacts warm pipes containing the heat transfer fluid. As the brine solution flows around these pipes, it absorbs heat, thereby increasing in temperature. This heated brine is then circulated back into the pond, contributing to an accelerated evaporation process.

The heat transfer fluid circuit comprises the heat transfer fluid for absorbing and carrying heat. The heat transfer fluid is initially pumped into the facility generating waste heat, such as the electrolyzers. Here, it absorbs the excess heat, effectively aiding in cooling the electrolyzers or other system generating the waste heat. Once heated, the heat transfer fluid is then directed out of the facility and into the heat exchanger located within or near the brine pond. In the heat exchanger, the heat transfer fluid flows through pipes that are immersed in the cooler brine solution. The heat from the heat transfer fluid is transferred to the brine, and as a result, the heat transfer fluid cools down. The cooled heat transfer fluid is then recirculated back to the facility, ready to absorb more waste heat, thus completing the cycle.

This closed-loop system creates a continuous flow of energy transfer, utilizing waste heat from facility operations to enhance the evaporation rate of the brine ponds. The design ensures that the heat is effectively captured and used, rather than being dissipated into the environment. This not only improves the efficiency of the brine evaporation process but also contributes to the overall energy efficiency of the facility's operations.

### Example 1

A system such as the one in FIG. 1 is employed with an electrolyzer producing hydrogen and heat wherein the electrolyzer has an installed capacity of 100 MW. The results show that 203,060 MWhth can be extracted from the electrolyzer annually with a waste heat temperature of 79° C.

### Example 2

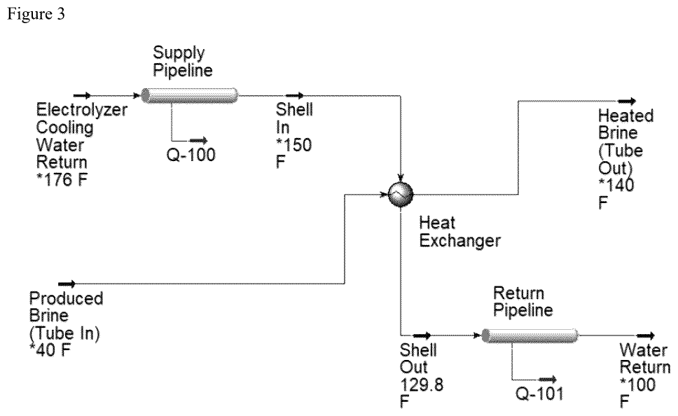

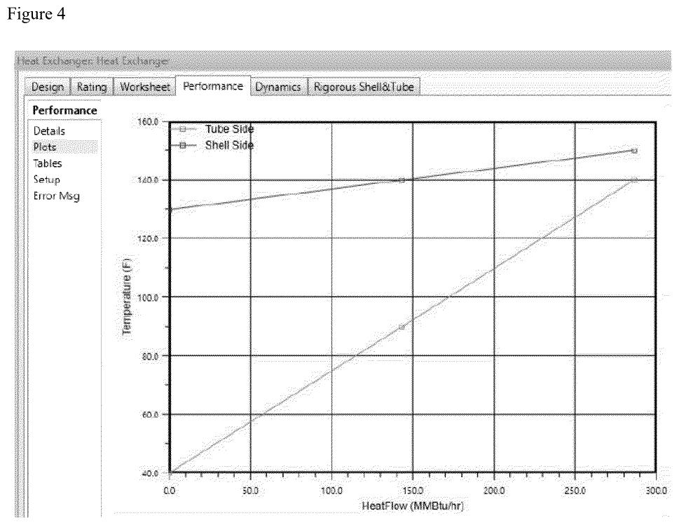

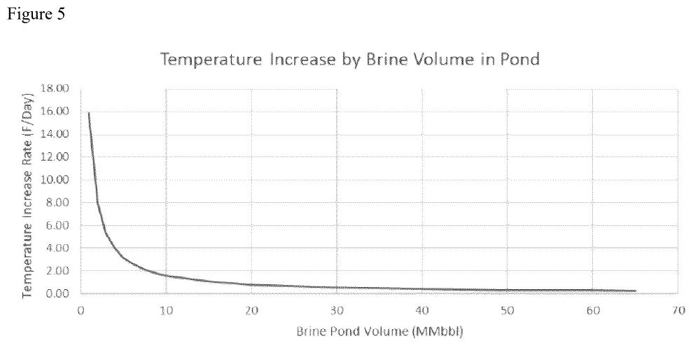

An electrolyzer cooling water return is provided via pipeline to shell side inlet (approximately 28,000 gallons per minute) while produced brine flow from two brine ponds is provided to the tube side inlet (approximately 4400 gallons per minute) in a system similar to FIG. 1. The temperatures of the fluids at various points in the closed loop system are shown in FIG. 3. As FIG. 4 shows, a 140F brine tube side outlet temperature results. FIG. 5 shows that the increase in brine pond temperature depends on brine volume within the pond.

It will be understood that various modifications may be made to the embodiments disclosed herein. Therefore, the above description should not be construed as limiting, but merely as exemplifications of example embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. An integrated process for producing hydrogen comprising:
producing hydrogen and heat from water using an electrolyzer;
heating a heat transfer fluid with the heat from the electrolyzer and pumping the heated heat transfer fluid to a heat exchanger;
pumping a brine solution from the brine pond to the heat exchanger comprising the heated transfer fluid to heat the brine solution; and
pumping the heated brine solution into the brine pond, a second brine pond, or both.

2. The process of claim 1 which further comprises pumping the heat transfer fluid from the heat exchanger to the electrolyzer after heating the brine solution.

3. The process of claim 1 wherein the heat exchanger comprises a shell and tube heat exchanger.

4. The process of claim 1 wherein the heat transfer fluid is a liquid.

5. The process of claim 1 wherein the heat transfer fluid comprises water.

6. The process of claim 1 which further comprises increasing the temperature of the heat transfer fluid, the brine solution, or both with one or more heat pumps.

7. The process of claim 1 wherein the heated brine solution is at least about 5 degrees Fahrenheit warmer than the brine solution from the brine pond.

8. The process of claim 1 wherein the heated brine solution at least about 10 degrees Fahrenheit warmer than the brine solution from the brine pond.

9. The process of claim 1 wherein the electrolyzer is a proton exchange membrane electrolyzer.

10. The process of claim 1 wherein the electrolyzer is an alkaline membrane electrolyzer.

11. A process for evaporating brine from a brine pond comprising:
heating a heat transfer fluid with waste heat and pumping the heated heat transfer fluid to a heat exchanger;
pumping a brine solution from the brine pond to the heat exchanger comprising the heated transfer fluid to heat the brine solution; and
pumping the heated brine solution into the brine pond, a second brine pond, or both.

12. The process of claim 11 wherein the waste heat comprises heat from an electrolyzer.

13. A system comprising:
an electrolyzer;
a heat exchanger fluidly connected to the electrolyzer;
a first pump configured to pump a heated heat transfer fluid from the electrolyzer to the fluidly connected heat exchanger;
a brine solution; and
a second pump fluidly connected to the brine solution and the heat exchanger, wherein the second pump is configured to pump the brine solution to the heat exchanger to form heated brine solution.

14. The system of claim 13 further comprising a third pump to pump (1) heat transfer fluid from the heat exchanger to the electrolyzer; (2) heated brine solution from the heat exchanger to a brine pond; or (3) both (1) and (2).

15. The system of claim 13 wherein the heat exchanger is a shell and tube heat exchanger.

16. The system of claim 13 further comprising a heat pump configured to increase the temperature of the heat transfer fluid, the brine solution, or both.

17. The system of claim 13 wherein the electrolyzer is a proton exchange membrane electrolyzer.

18. The system of claim 13 wherein the electrolyzer is an alkaline membrane electrolyzer.

19. The system of claim 13 which further comprises a brine pond comprising the brine solution.

20. The system of claim 13 which further comprises a solar umbrella to at least partially cover the brine pond.
